(19) United States
(12) Patent Application Publication
(10) Pub. No.: US 2007/0267478 A1
(43) Pub. Date: Nov. 22, 2007

(54) Controlled and secure transactions

(76) Inventors: Joseph J. Turek, Palmer, MA (US); Katrina Champagne, Palmer, MA (US)

Correspondence Address: ASHOK TANKHA;OF COUNSEL, LIPTON, WEINBERGER & HUSICK, 36 GREENLEIGH DRIVE, SEWELL, NJ, 08080, US

(21) Appl. No.: 11/438,498

(22) Filed: May 22, 2006

(51) Int. Cl. G07F 19/00; G06Q 40/00

(52) U.S. Cl. 235/379; 705/44

(57) ABSTRACT

A system and method are disclosed herein for allowing an account holder to deposit money in an account to allow an authorized purchaser to spend up to a pre-allocated amount of money for the purchase of goods or services from a predetermined merchant on a network in communication with a server. The account holder and authorized purchaser first enroll and registers at the allocation engine. The allocation engine verifies and authenticates the account holder using the verification details provided by the account holder during the registration process. Prior to a purchase, the identity of the authorized purchaser is first verified at the merchant premises. The allocation engine then processes the purchase request of the purchaser, by comparing the requested transaction information of the authorized purchaser to the permitted transactions authorized by the account holder as stored in the allocation engine. The merchant updates the purchase information into the allocation engine, confirming that the authorized individual has made a purchase up to the pre-allocated amount. The allocation engine comprises an enrollment module, registration module, update module, database, verification module and reporting module.

### BACKGROUND OF THE INVENTION

The present invention, in general, relates to monetary transactions and specifically relates to a system and method of controlling the monetary amount that may be transacted by a person at a merchant. The most common mode of transactions is in the form of cash or credit/debit cards. One inherent problem that currently exists with the current method and means of payment is its inability to control the purchase behavior of the person making the purchase.

There is an unmet market need for a method and system that directs and allows control of the amount of money that may be spent by an individual on a transaction, for example, a method that controls the amount of money that an individual can spend at any one or more transactions at a merchant, or the amount of money that can be spent by an individual over any period of time, for example on any day, or between a certain time period. For example, the method and system disclosed herein allow parents to regulate the spending behavior of children at one or more merchants, but by not giving money to their children, disallow the purchase of cigarettes, alcohol, drugs and other undesirable products and services.

There is an unmet market need for a method and system that enables the control of an expense in one or more of the following dimensions: monetary value of transaction, type of good purchased, merchant, time and location.

### SUMMARY OF THE INVENTION

The method and system disclosed herein controls the spending behavior of a purchaser by an account holder, by permitting the purchaser to spend up to a predetermined amount of money at predetermined merchants. The account holder enrolls and registers at the allocation engine. The allocation engine verifies and authenticates the account holder using the verification details provided by the account holder and the individual authorized to spend the money during the registration process. The account holder updates the spending allocation information at the allocation engine by entering information for the predetermined amount of money allocated to one or more predefined individuals at a predetermined merchant(s). The merchant first verifies the identity of the authorized purchaser. The allocation engine then processes the purchase request of the authorized purchaser up to the amount authorized by the account holder, by comparing the requested transaction information of the authorized purchaser to the permitted transactions authorized by the account holder as stored in the allocation engine. The merchant enters the transaction information into the allocation engine and confirms that the permitted individual has spent the allocated amount. The allocation engine thereafter updates the account information of the authorized individual. The allocation engine comprises an enrollment module, registration module, update module, database, verification module, reporting module, time module, reservation module, data storage and analysis module, transaction confirmation module and alert notification module. The merchant-computing device optionally comprises a biometric device for authenticating the transaction of the permitted predefined individuals. The merchant computing device and account holder computing device can be one or more of the following devices: desktop computers, mobile computers, mobile phones and other types of devices with computing and communicating components.

The allocation engine recognizes the account holder and grants access to the account using the verification details provided by the account holder. The account holder updates the spending information at the allocation engine by inputting information for a predetermined amount of money, authorized purchasers and predetermined merchants. The identity of the authorized purchaser is first verified at the merchant premises 104. The allocation engine then processes the purchase request of the purchaser, by comparing the requested transaction information of the authorized purchaser to the permitted transactions authorized by the account holder stored in the allocation engine. The merchant updates the spending information in the allocation engine. The allocation engine transmits details of updated spending information to the account holder at time intervals and by communication means specified by the account holder.

The method and system disclosed herein controls the spending habits of the customers by predetermining expense allocation for specific merchants. Consider the example where a parent transfers $100 to the child's controlled account for particular merchants. The child is allowed to spend $20 at Sears, $30 at the movies, $40 at Filenes and $10 at McDonalds. Thus the spending habits of children can be tracked and restricted, whereby children do not spend money on undesirable goods or products or overspend on products or services.

The method and system disclosed herein enables users to record and track spending behavior, i.e., track the amount spent on a particular product and identify the location at which the transaction is carried out.

The system and method disclosed herein can be applied to any value based transaction, such as transaction based on value points, and is not restricted to monetary transactions.

The system and method disclosed herein provides the ability to set time-based control of purchases.

The method and system of this invention provides a reservation capability. The value points or money can be used in conjunction with a reservation system.

The method and system of this invention also supports credit transactions. If the price of the product/article is greater than the predetermined amount of money that has been deposited in the regulated transaction account, the merchant can optionally credit the excess amount to the account of the account holder.

The method and system disclosed herein can be used by the merchants to advertise discounts, special offers, validity and expiry of points, etc. to the account holder.

The method and system of this invention supports expense behavior analysis and customer purchase trends. This information is useful to both the account holders and the merchants.

The method and system of this invention supports a transaction confirmation system.

The method and system of this invention supports an alerting and notification system.

### BRIEF DESCRIPTION OF THE DRAWINGS

Embodiments of the method and system will now be described, by way of example only, with reference to the attached Figures.

FIG. 1 illustrates a method of regulating the spending behavior of a purchaser by an account holder, by permitting the purchaser to spend allocated predetermined amounts of money only at predetermined merchants chosen by the account holder.

FIG. 2A illustrates a system for regulating the spending behavior of a purchaser by an account holder, by permitting the purchaser to spend allocated predetermined amounts of money only at predetermined merchants chosen by the account holder.

FIG. 2B illustrates the components of the allocation module.

### DETAILED DESCRIPTION OF THE INVENTION

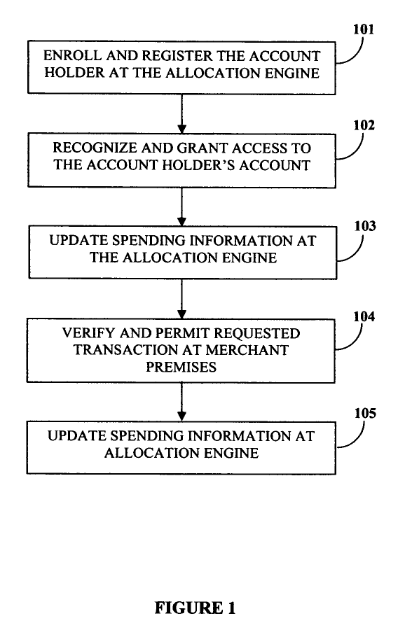

FIG. 1 illustrates a method of regulating the spending behavior of a purchaser by an account holder, by permitting the purchaser to spend allocated predetermined amounts of money only at predetermined merchants chosen by the account holder. The account holder enrolls and registers at the allocation engine 101. The allocation engine verifies and authenticates the account holder using the verification details provided by the account holder during the registration process 102. The account holder updates the spending allocation information at the allocation engine 103 by entering information for a predetermined amount of money that is allocated to a permitted predefined individual for expense at a predetermined merchant. The identity of the authorized purchaser is first verified at the merchant premises 104. The allocation engine then processes the purchase request of the purchaser, by comparing the requested transaction information of the authorized purchaser to the permitted transactions authorized by the account holder stored in the allocation engine. The merchant updates the transaction information into the allocation engine 105, and confirms that the permitted individual has spent the allocated amount.

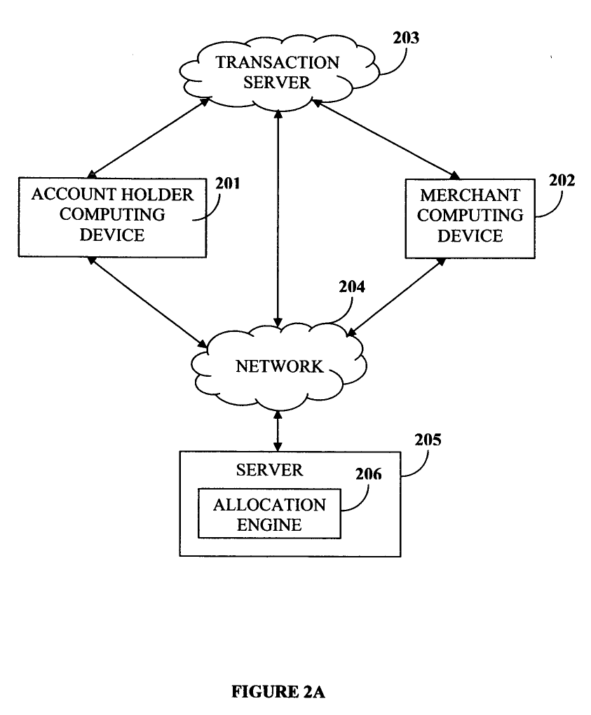

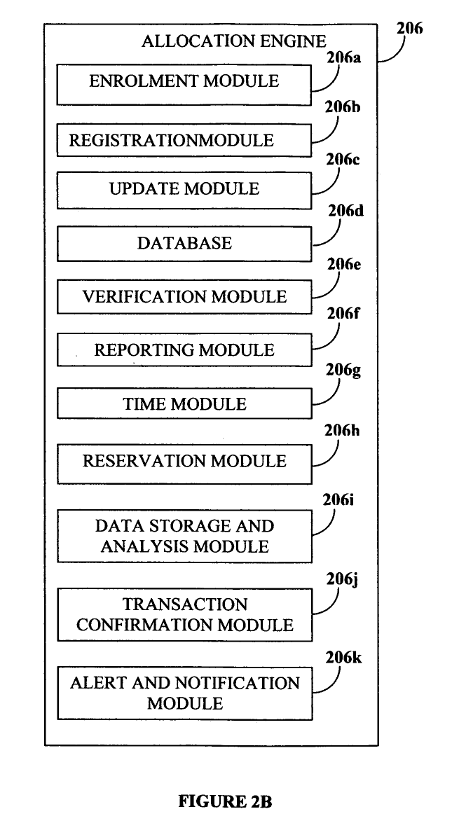

FIG. 2 illustrates the system used for regulating the spending behavior of a purchaser by an account holder, by permitting the purchaser to spend allocated predetermined amounts of money only at predetermined merchants chosen by the account holder. The account holder-computing device 201 is connected to the network 205. The account holder-computing device 201 can be any device with a processor, memory and communication component, including, but not limited to a personal computer or a mobile phone. An account holder uses the account holder-computing device 201 to allocate a predetermined amount of money to one or more selected merchants. The allocation engine 206 that is in communication with the account holder-computing device 201 processes the spending allocation request of the account holder. The allocation engine 206 located in a server 205 is in communication with a transaction server 203. The transaction server 203 can be part of an on-line banking infrastructure. Each account holder is provided with a unique identification number for accessing the account and processing transactions with the allocation engine 206. The account holder enters the name of the authorized purchaser who is permitted to purchase the product or services, the allocated amount, i.e., the predetermined amount and the account number of the merchant or the name of the merchant to whose account the predetermined amount of money has to be allocated. This information is transferred to the allocation engine 206 over the network 204. The network is inclusive of, but not restricted to the internet, corporate intranet, local area network, etc. The allocation engine searches its database 206d to verify the merchant's account number, and the specified amount of money allocated by the account holder to the recipient's account, i.e., the purchaser's account. The transaction server 203 and the allocation engine 206 are shown as separate and discrete units in FIG. 2B. However, the transaction server 203 and the allocation engine 206 can be collocated or their functionalities merged into one module.

The merchant-computing device 202 is an electronic device similar to a credit card reader, a computer or a mobile device that is connected to the internet. After a purchaser attempts a transaction, the result of the transaction is displayed on the merchant-computing device 202. Further, using the merchant-computing device 202, the merchant can connect to the allocation engine 206 and search the database 206d to view the expense allocations by one or more account holders at their store. The merchant can use also this information for inventory management.

The merchant-computing device 202 optionally consists of a biometric device for verifying the identity of the purchaser. Biometrics authentication is performed by capturing the physiological and behavioral characteristics of the purchaser, for example, face shape, iris, fingerprints, voice, etc. Identity authentication is performed by comparing the captured biometric data against a pre-stored biometric template of the authorized purchasers. The pre-stored biometric template is captured during the enrollment of the account holder and the authorized purchasers. The pre-stored biometric templates are stored in the database 206d. Prior to making a purchase, the purchaser makes a claim of identity. The allocation engine 206 verifies this identity claim by comparing the identity of the purchaser against the submitted registered sample, i.e., the pre-stored biometric template. If there is a match between the identity previously provided and stored in the database versus the identity provided by the purchaser at the time of purchase, the identification of the individual is positive. The purpose of a positive identification is to prevent the use of a single identity by more than one individual.

The account holder computing device 201 and the merchant-computing device 202 are connected to the allocation engine 206 through the network 204 and are in communication with the transaction server 203 either directly or via the network 204.

One form of the network 204 is the internet. The internet is a publicly accessible worldwide system of interconnected computer networks that transmits data by packet switching using a standardized internet protocol (IP). It is made up of commercial, academic, domestic, and government networks such as LANs (local area networks) and WANs (wide area networks). It carries various information and services, such as electronic mail, the interlinked web pages and other documents of the interconnected computers.

The electronic transactions between the authorized purchaser and the merchant is performed via the transaction server 203.

FIG. 2B illustrates the components of the allocation module. The allocation engine 206 consists of an enrollment module 206a, registration module 206b, update module 206c, database 206d, verification module 206e, reporting module 206f, time module 206g, reservation module 206h, data storage and analysis module 206i transaction confirmation module 206j and alert notification module 206k.

The enrollment module 206a enables the account holder to enroll himself or herself formally as a member of the allocation engine 206 for regulating transactions of purchasers.

The registration module 206b collects relevant information from the account holder, such as the account holder's name, address, password, etc. The registration information of the account holder is stored at the allocation engine 206. The allocation engine 206 manages an official documented record of names, events or transactions taking place through a particular user account. When the account holder registers with the allocation engine 206, the allocation engine 206 provides the account holder with a user name and password. Once the account holder is registered with the server, the account holder's information is stored in the allocation engine 206, and all the transactions taking place through a particular account is tracked and recorded in the allocation engine 206.

The account holder updates the spending information at the allocation engine 206 using the update module 206c. The account holder inputs information on the predetermined amount of money available for use by the authorized purchaser at one or more predetermined merchants. The update module 206c updates the spending information of the merchant into the allocation engine 206, and makes the necessary deductions in the account when the permitted individual makes a purchase of goods or services from the allocated amount. The update module 206c stores transaction data and establishes a communications link with the merchant, receives the request for a transaction from the account holder, records the transaction in the allocation engine 206, forwards the transaction request to the merchant, receives update data from the merchant and updates the information in the update module 206c of the allocation engine 206 based on the update data received.

The database 206d is an organized body of related information. Data on the account holder and the merchant is stored in the database 206d, including data such as the account holder's and the merchant's name, their respective account numbers, addresses, and the list of transactions for both the account holder and the merchant. The database 206d also includes a collection of records of the transactions taking place through the allocation engine 206.

The verification module 206e verifies the purchaser's requested transaction at the merchant premises by comparing the requested transaction information of the permitted individual to the permitted transactions authorized by the account holder that is stored in the allocation engine 206. Verification module 206e authenticates and approves or disapproves the identity of the authorized purchaser with respect to a certain formal specification or information provided by the account holder to the allocation engine 206. If the information by the purchaser to the merchant conforms with the information provided by account holder to the allocation engine 206, then it is a positive verification and the authorized purchaser is allowed to complete the purchase transaction.

The reporting module 206f tracks the transactions taking place through the allocation engine 206, including information on the account holder, the merchants account numbers, the amount of money allocated by the account holder, the permitted individuals name, amount of money spent by the permitted individual and the acknowledgement from the merchant stating that the stipulated amount of money has been spent. Once the transaction has been completed, and the merchant has received the payment for the purchase, the merchant sends an acknowledgement to the allocation engine 206 reporting that the authorized individual has spent the stipulated amount of money.

The system and method disclosed herein can be generally applied to any value transaction, and is not restricted to monetary transactions. For example, value points, coupons, tickets, etc., instead of money, can be stored in the purchaser' device to allow a transaction to be conducted at the merchant premises. Value points are applicable in a restricted economy, for example points can be allocated for purchasing education related materials from authorized merchants at a university. Such points can only be traded within the confines of such a restricted economy. If the cost of a product purchased is less than the pre-determined amount of points allocated for the purchase of that product, the excess number of points can be carried over for the next purchase. Discounts can be tied in to repeated purchases, or per the discount rules set by the merchant. For example, if a purchaser purchases all of his or her textbooks at one merchant, the merchant can provide a discount in the form of additional points that can only be used for purchase of items in the merchant's store. Hence, the method and system of this invention is an efficient mechanism for issuing merchant and item specific discounts. Discount points can also be issued based on the frequency of use. For example, if the account is used at predetermined minimum number of times every month, the account holder is entitled to discount points.

Money or points can be issued for a merchant, wherein the money or points can be applied for transactions in any store of a merchant. For example, a $6 value can be allocated for purchase of a salad and hamburgers at McDonalds, wherein this $6 value can be spent in any McDonald's store in the country. The method and system disclosed herein facilitates the application of loyalty programs. For example, Dell Inc., being a preferred merchant of Microsoft Inc., may provide discounts in the form of value points to employees of Microsoft Inc. for the purchase of laptop computers for the employee's personal use. These value points can only be traded for Dell's laptop products, and not traded for Dell's digital cameras.

The time module 206g within the allocation engine 206 introduces the time dimension to these value points or money transacted. A pre-allocated amount of money can be programmed to be valid only for a pre-determined time. The money in the account becomes invalid after the lapse of this predetermined time limit. For example, a father may allocate a $7 expense for a movie theatre ticket for his son at AMC Cinema on a specific date. The son cannot use this $7 value on any day other than this specific date. The current cash and credit card system of payments do not permit time-based control of transactions. Merchants can provide discount points that have a set expiry date.

The reservation module 206h in the allocation engine 206 provides reservation capability. The value points or money can be used in conjunction with a reservation system. For example, a father can reserve a movie ticket in the name of his son for a particular movie at the AMC Cinema.

The method and system of this invention also supports credit transactions. If the price of the product/article is greater than the pre-allocated amount of money that has been deposited in the regulated transaction account, the merchant can optionally credit the excess amount to the account of the account holder. For example, assuming the customer only has $7 allocated for their use in the regulated transaction system, and if the movie ticket costs $8, AMC Cinema may optionally provide a $1 credit to a customer.

The data storage and analysis module 206i located within the allocation engine 206 allows the account holder and merchants to analyze purchase behavior. This information is useful to both the purchasers and the merchants. Merchant's can use this information to streamline their supply chain management, and utilize it for demand forecasting. For example, if parents of young moviegoers in a small town allocate expense money for their children on a particular Friday, the movie theatre can then use this information to decide on the number of movie screenings that would accommodate the expected audience. AMC Cinema will then know beforehand the number of customers on that particular Friday.

The transaction conformation module 206j in the allocation engine 206 supports transaction confirmation system. For example, a father can allocate $20 at a certain drug store for the purchase of flu medicines by his son. However, if the son where to purchase any other drugs, such as a pain releiver, a transaction confirmation request will be sent to the father via one or more communication means, including but not restricted to short message service (SMS), e-mail, etc.

The alert and notification module 206k within the allocation engine 206 provides alerting and notification services. For example, if the cash balance in a controlled account falls below a certain threshold, an alert message is sent to the account owner indicating the need to replenish the account with additional funds. For example, a father can set a $20 minimum threshold in the account of his son, wherein if the account balance falls below $20, an alert in the form of a SMS, e-mail or automated voice message is transmitted to the father.

The alert and notification module 206k can also be used by the merchants to advertise discounts, special offers, expiry of points, etc., to the account holder.

The method and system of this invention is not restricted to purchases at the physical premises of the merchant. The regulated transactions can take place using electronic commerce, for example, over the website of the merchant. The regulated transactions can also take place via a telephone call with the merchant. The authentication process via the website is performed using a username and password. In the case of the telephone call with the merchant, authentication of the purchaser is performed using a personal identification number (PIN).

The method and system disclosed herein can be used, for example, by an amusement park to control the spending behavior or to restrict certain rides for certain categories of visitors, for example, visitors below a certain age; by a fleet transportation company to control the purchase of gasoline, etc. by its truck drivers; by a construction contractor to control the purchase of materials by its sub-contractors; by a corporation to control the spending on a contract, for example a research and development contract; by a governmental agency to control the spending of funds allocated to a certain project by private contractors, etc.

The foregoing examples have been provided merely for the purpose of explanation and are in no way to be construed as limiting of the present method and system disclosed herein. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A system for allowing an account holder to deposit money in an account to allow an authorized purchaser to spend up to a pre-allocated amount of money for the purchase of goods or services from a predetermined merchant on a network in communication with a server, comprising:
an account holder computing device for inputting information on the authorized purchaser, the predetermined merchant and the money allocated;
a transaction server located on said server that is accessed by the account holder and merchants;
an allocation engine residing on the server in communication with said transaction server, wherein said allocation engine allows the account holder to deposit money in the account holder's account against which the authorized purchaser can make purchases up to the amount of money deposited for the authorized purchaser; and
a merchant computing device used by the merchant, said computing device in communication with said transaction server and allocation engine.

2. The system of claim 1, wherein said allocation engine further comprises an enrollment module, registration module, update module, database, verification module, reporting module, time module, reservation module, data storage and analysis module, transaction confirmation module and alert notification module.

3. The system of claim 1, wherein said merchant computing device further comprises a biometric device for authenticating the identity of the authorized purchaser prior to the purchase of goods or services.

4. The system of claim 1, wherein the merchant computing device and account holder computing device are one or more of the following devices: desktop computers, mobile computers, mobile phones and other types of computing devices with communication means.

5. The system of claim 1, wherein value points are used instead of money.

6. The system of claim 1, wherein the allocation engine further comprises a time module that sets time criteria for purchases.

7. The system of claim 1, wherein the allocation engine further comprises a reservation module for scheduling reservations for the purchase of goods or services from merchants.

8. The system of claim 1, wherein the allocation engine permits credit based transaction between the merchant and the authorized purchaser.

9. The system of claim 1, wherein the allocation engine enables merchants to advertise discounts, special offers, validity and expiry of discounts.

10. The system of claim 1, wherein the allocation engine further comprises a confirmation module for confirming the transaction between an authorized purchaser and a merchant.

11. The system of claim 1, wherein the allocation engine further comprises an alert and notification module for generating and transmitting alerts and notifications from the merchant to the account holder.

12. A method for allowing an authorized purchaser to make a purchase up to a pre-allocated amount of money at predetermined merchants as specified by an account holder where such transaction is conducted over a server in communication with an allocation engine residing on a network, comprising the steps of:
enrolling and registering said account holder at the allocation engine;
authenticating said account holder and granting access to the account holder's account using verification details provided by the account holder;
updating the purchase information at the allocation engine by the account holder inputting information on pre-allocated amount of moneys by the authorized purchaser at predetermined merchants;
verifying the authorized user's transaction at the merchant premises by comparing the requested transaction information of the authorized purchaser to the transactions authorized by the account holder stored in the allocation engine; and
updating the spending information stored in the allocation engine from the merchant.

13. The method of claim 12, wherein the enrollment and registration step further comprise the step of inputting the identity information of the permitted predefined individuals.

15. The method of claim 12, wherein the identity information comprises biometric identification.

16. The method of claim 12, wherein the step of verifying the authorized purchaser's requested transaction further comprises the step of biometric identification.

17. The method of claim 12, where the predetermined merchants are chosen based upon geographic preference.

18. The method of claim 12, wherein value points are used instead of money.

19. The method of claim 12, wherein time limits are set for purchases authorized by the account holder.

20. The method of claim 12, wherein the account holder schedules reservations for the purchase of goods or services from predetermined merchants.

21. The system of claim 12, wherein the account holder can permit credit based transaction between the merchant and the authorized purchaser.

22. The system of claim 12, wherein the merchant advertise discounts, special offers, validity and expiry of discounts to the account holder.

23. The method of claim 12, wherein alerts and notifications are sent from the merchant to the account holder.
